(19) United States
(12) Patent Application Publication
(10) Pub. No.: US 2013/0291041 A1
(43) Pub. Date: Oct. 31, 2013

(54) METHOD AND MODULE DEVICE FOR CONTROLLING NETWORK ACCESS OF A TELEVISION DEVICE

(71) Applicant: Ka Wing Cheung, TST East (CN)

(72) Inventor: Ka Wing Cheung, TST East (CN)

(73) Assignee: Quatius Limited

(21) Appl. No.: 13/604,866

(22) Filed: Sep. 6, 2012

(30) Foreign Application Priority Data
Apr. 25, 2012 (CN) 201210126042.0

(51) Int. Cl. H04N 21/20

(52) U.S. Cl. 725/110

(57) ABSTRACT

A method for controlling network access of a television device and a module device thereof are disclosed. The method includes the following steps: inserting a network link tag in a television video, the network link tag recording a network link corresponding to the television video; transmitting the television video to the television device for playing; capturing the network link tag on the television video currently playing on the television device when receiving a network access instruction for acquiring the television video; and analyzing the network link tag to obtain the network link corresponding to the television video. This is very simple and convenient in operation. The network accessing to obtain the content of television video can thus be controlled by one button.

### RELATED APPLICATIONS

This application claims the priority of, and hereby incorporates by reference, Chinese patent application serial no. 201210126042.0, filed Apr. 25, 2012.

### FIELD OF THE INVENTION

The present invention relates to the field of network access of a television device, and in particular to a method and module device for controlling network access of a television device.

### BACKGROUND OF THE INVENTION

Generally, during the playing of television video, a user who is interested in the content of the television video (including advertisement) and intends to obtain the corresponding information of the television video has to search on the Internet to obtain this video. However, it is troublesome for the user to remember the content of the television video and then search it on the Internet. Especially, for a user who is not familiar with the Internet, it will be very difficult for him.

Therefore, even if a user is interested in the television video content, the user may skip it due to not knowing how to obtain the content of the television video or the time consuming to give up TV enjoy and go to the computer or mobile.

### SUMMARY OF THE INVENTION

In consideration of the above-stated problems in the prior art, it is an object of the present invention to provide a method for controlling network access of a television device, which enables a user to obtain the television video easily without having to remember the television video content or website in order to search it on the Internet.

According to one aspect of the invention, a method for controlling network access of a television device comprises the follow steps:
receiving a network access instruction for acquiring a television video;
capturing a network link tag preset on the television video currently playing on the television device; and
analyzing the network link tag to obtain a network link corresponding to the television video.

According to a further aspect of the invention, a method for controlling network access of a television device comprises the follow steps:
inserting a network link tag in a television video, the network link tag recording a network link corresponding to the television video;
transmitting the television video to the television device for playing;
capturing the network link tag on the television video currently playing on the television device when receiving a network access instruction for acquiring the television video; and
analyzing the network link tag to obtain the network link corresponding to the television video.

Furthermore, it is a further object of the present invention to provide a module device for controlling network access of a television device.

According to one aspect of the invention, a module device for controlling network access of a television device comprises:
a trigger module configured to receive a network access instruction for acquiring a television video;
a tag identification module configured to capture a network link tag preset on the television video currently playing on the television device; and
a link acquisition module configured to analyze the network link tag to obtain a network link corresponding to the television video. With the method and module device of the present invention, if a user is interested in a television video when watching television, then he may trigger the network access instruction for acquiring the television video by a button on the television remote controller, or the television device, etc. The television video content can be a movie, TV program, sports, advertisement, etc. The control software of digital television receives the network access instruction, identifies and captures the network link tag preset on the television video (properly QR mark but not necessary limited), and analyzes the network link tag to obtain the network link corresponding to the television video. The user can access the directed network immediately through the network link to obtain the corresponding television video. This is very simple and convenient in operation. The network accessing to obtain the television video can thus be controlled by one button.

The network link tag may be inserted into the television video beforehand by the television station or digital television operators or program producer. The network link tag records the corresponding network link of the television video that is then transmitted to the television device to be displayed. After the user receives the television video in his television device, the method and module device for controlling the network access can be implemented in his television device, and thus the network accessing to obtain the directed content of the website can thus be controlled by one button.

Furthermore, after obtaining the network link, the network link may be opened directly to display the content corresponding to the network link to the user. Alternatively, the network link may be stored firstly, and the network link is not opened until an instruction from the user is received. In this way, the television program currently playing will not be interrupted while it is convenient for the user to access the network link to obtain the television video content.

### BRIEF DESCRIPTION OF THE DRAWINGS

FIG. 1 is a flowchart of a method for controlling network access of a television device according to an embodiment;

FIG. 2 is a schematic two-dimensional code preferably used in the method of the present invention;

FIG. 3 is a flowchart of a method for controlling network access of a television device according to a preferred embodiment;

FIG. 4 is a schematic structure diagram of a module device for controlling network access of a television device according to an embodiment;

FIG. 5 is a schematic structure diagram of a module device for controlling network access of a television device according to a preferred embodiment.

### DETAILED DESCRIPTION OF THE PREFERRED EMBODIMENTS

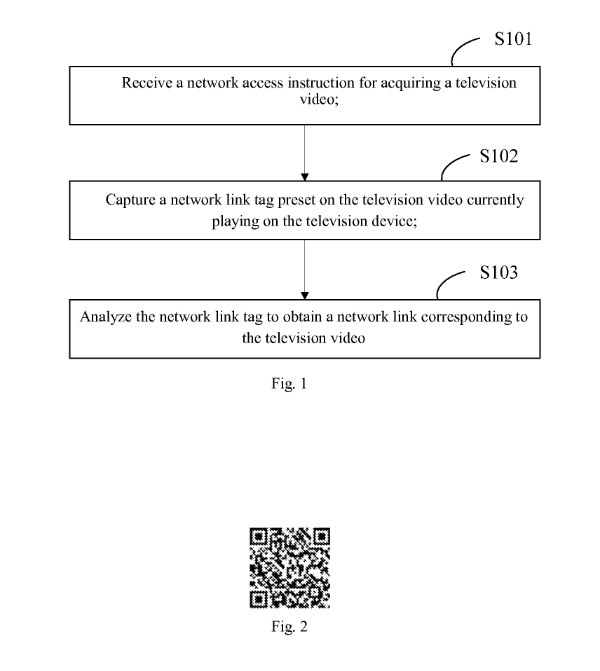

Referring to FIG. 1, it shows a flowchart of a method for controlling network access of a television device.

The method for controlling network access of television device comprises the following steps:

Step S101: receiving a network access instruction for acquiring a television video.

In this step, during the playing of television program, a network access instruction for acquiring the television video is triggered through a specific button provided on the television remote controller or the television device. Alternatively, an existing button on the television remote controller or the television device may be set to a specific triggering manner for the network access instruction for acquiring the television video. For example, a network resource searching button is provided on the television remote controller or the television device, or a long press, as a trigger of network access instruction for acquiring the television video, is set on the television remote controller or the television device.

The content of television video may be a movie, a TV program, sports, advertisement, etc., which is not limited.

Step S102: capturing a network link tag preset on the television video currently playing on the television device.

The network link tag can be in various forms, and mainly for recording the corresponding network link of the television video. The network link tag may be inserted into the television video beforehand by the television station or digital television operators. The television video is then transmitted to the television device of the user for displaying. The network link tag recording the corresponding network link of the television video enables the method and module device of the invention to be implemented in the television device of the user after the corresponding television video is received by the user. The network accessing to obtain the content of television video can thus be controlled by one button.

The entire image or a part of the image is captured in the step of capturing a network link tag preset on the television video currently playing on the television device.

That is, an entire image of the television video currently playing on the television device may be captured and then the network link tag is captured on a specific position of the television image. Alternatively, a specific position of the television image where the network link tag is located is captured directly.

Preferably, the network link tag is a two-dimensional code set at the edge of the image of the television video. The two-dimensional code commonly used is shown in FIG. 2. The advantage of using the two-dimensional code is that the two-dimensional code is able to contain a large amount of data but occupy a space as small as 1.5 cm*1.5 cm, while the quality of television video will not be affected. A further advantage of using two-dimensional code is that the complete data can be obtained even though the image is not entirely captured.

Step S103: analyzing the network link tag to obtain a network link corresponding to the television video.

In this step, the captured network link tag is analyzed. For example, if the network link tag is a two-dimensional code, then the two-dimensional code is decoded to obtain the network link recorded in the two-dimensional code.

In the method for controlling network access of television device, a network access instruction for acquiring the television video is triggered via a button on the television remote controller or the television device, if a user is interested in a television video during watching television. The control software of digital television receives the network access instruction, identifies and captures the network link tag preset on the television video, and analyzes the network link tag to obtain the network link corresponding to the television video. The user can access the network through the network link to obtain the corresponding content of the television video. This is very simple and convenient in operation. The network accessing to obtain the content of television video can thus be controlled by one button.

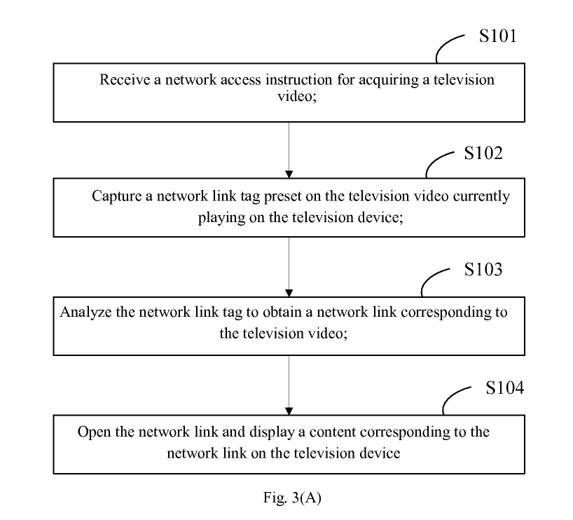

Furthermore, as shown in FIG. 3, the following steps are performed after the step S103 of obtaining the network link corresponding to the television video:

Step S104: open the network link, and display the content corresponding to the network link on the television device, as shown in FIG. 3 (A).

Or, step S105: store the network link, then open the network link and display the corresponding content of the network link on the television device when receiving an instruction to access the network link, as shown in FIG. 3 (B).

In the step S104, after the user presses the button to trigger the network access instruction for acquiring the television video, the network link is opened directly, and the content corresponding to the network link is displayed on the television device. Thus, the switching between different modes of the television device and the automatic playing of the television video on the network can be realized by one button.

In the step S105, without interrupting the television video currently playing, the network link is stored at first, and only after the user triggers the network access instruction for acquiring the television video, the network link is opened to display the content corresponding to the network link on the television device. Therefore, the corresponding network link may be opened at any time when desired, and the current television program will not be affected.

In the step S104 and the step S105, the step of opening the network link and displaying the content corresponding to the network link on the television device may be achieved in the following way: switch the television device into the network mode; and then open the network link in the network mode, and display the video content corresponding to the network link on the television device.

The network link may be directed to an online video itself, or a list of online videos. As a preferred embodiment, a playing progress information is recorded beforehand in the network link tag. Then, a playing progress of video content on the network link is set according to the playing progress information when the video content on the network link is acquired and displayed on the television device.

That is, the network link tag pre-inserted in each frame of television image not only records the network link corresponding to the television video, but also records the playing progress information of the television video currently playing with respect to the entire television program. The corresponding network link and the playing progress information of the television video can be obtained after analyzing the network link tag. The corresponding online video may be opened according to the network link, and the playing progress may be set according to the playing progress information.

For example, the television image currently playing on the television device is an image at four minutes and thirty seconds from the beginning of the entire program. At this moment, if the user presses the specific button to trigger the network access instruction for acquiring the television video, then according to the method for controlling network access of the television device, the network link tag such as a two-dimensional code at the current television video is captured and then decoded to obtain the network link corresponding to the television video and the playing progress information of television video, four minutes and thirty seconds. Then, open the network link and display the online video which the network link is directing to, and the playing progress is set to four minutes and thirty seconds. This allows the user to obtain an experience of watching television without interrupting.

Furthermore, after the television device is switched to the network mode, it can be switched back to the television mode if an instruction for returning to the television mode is received. Then, the current television video when the television device returns to the television mode is displayed. Thus, the television device may be easily switched between the television mode and the network mode.

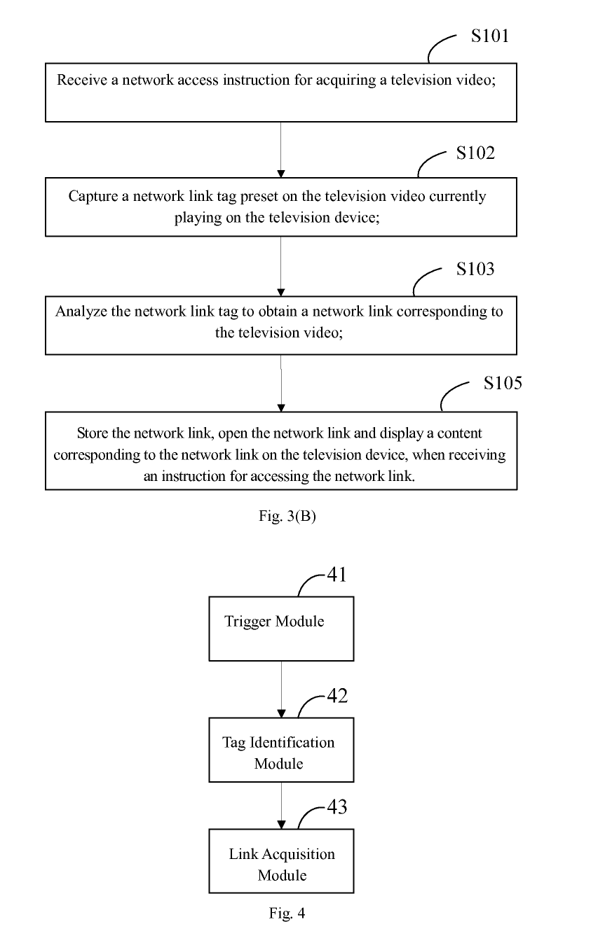

Referring to FIG. 4, a schematic structure diagram of the module device for controlling network access of the television device is shown.

The module device for controlling network access of the television device includes a trigger module 41, a tag identification module 42 and a link acquisition module 43.

The trigger module 41 is configured to receive the network access instruction to acquire the television video.

The tag identification module 42 is for capturing the network link tag preset on the television video currently playing on the television device.

The link acquisition module 43 is for analyzing the network link tag to obtain a network link corresponding to the television video.

The trigger module 41 receives the network access instruction for acquiring the television video triggered by the specific button set on the television remote controller or the television device. Alternatively, an existing button on the television remote controller or the television device may be set to a specific triggering manner for the network access instruction for acquiring the television video. For example, a network resource searching button is provided on the television remote controller or the television device, or a long press, as a trigger of network access instruction for acquiring the television video, is set to an existing button on the television remote controller or the television device. The television video content may be a movie, TV program, sports, advertisement, etc., which is not limited.

The network link tag can be in various forms, and mainly for recording the corresponding network link of the television video.

The network link tag may be inserted into the television video beforehand by the television station or digital television operators, and transmitted to the television device of the user together with the television video. The network link tag recording the corresponding network link of the television video enables the module device of the invention to be implemented in the television device of the user after the corresponding television video is received by the user. The network accessing to obtain the content of television video can thus be controlled by one button.

The entire image or a part of the image is captured when the tag identification module 42 captures a network link tag preset on the television video currently playing on the television device.

That is, the tag identification module 42 may capture the entire television video currently playing on the television device, and then capture the network link on a specific position of the image of the television video. Alternatively, a specific portion of the television image where the network link tag is located is captured directly.

Preferably, the network link tag is a two-dimensional code set at the edge of the image of the television video. The advantage of using the two-dimensional code is that the two-dimensional code can contain a large amount of data but occupy a space as small as 1.5 cm*1.5 cm, while the quality of television video will not be affected. Furthermore, a further advantage of using the two-dimensional code is that the complete data can be obtained even though the image is not entirely captured.

The network link tag captured by the tag identification module 42 is analyzed by the link acquisition module 43. For example, the network link tag is a two-dimensional code, and then the two-dimensional code is decoded to obtain the network link recorded in the two-dimensional code.

With the module device for controlling network access of television device, a network access instruction for acquiring the television video is triggered via a button on the television remote controller or the television device, if a user is interested in a television video during watching television. The control software of digital television receives the network access instruction, identifies and captures the network link tag preset on the television video, and analyzes the network link tag to obtain the network link corresponding to the television video. The user can access the network through the network link to obtain the corresponding content of the television video. This is very simple and convenient in operation. The network accessing to obtain the television video can thus be controlled by one button.

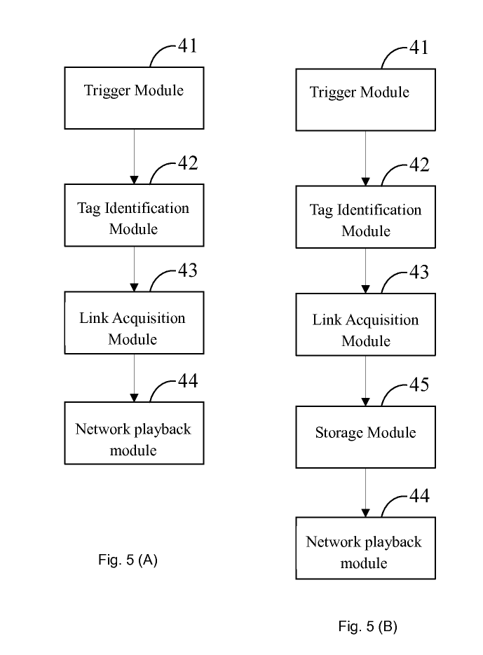

Furthermore, the module device further includes a network playback module 44 or further includes a storage module 45, as shown in FIGS. 5(A), 5(B).

The network playback module 44 is for opening the network link and displaying a content corresponding to the network link on the television device, after the link acquisition module 43 obtains the network link corresponding to the television video.

The storage module 45 is for storing the network link after the link acquisition module 43 obtains the network link corresponding to the television video. The network playback module 44 opens the network link and displays a content corresponding to the network link on the television device when receiving an instruction for accessing the network link.

After the user presses the button to trigger the network access instruction for acquiring the television video, the network playback module 44 will open the network link directly and display the corresponding content of network link on the television device. Thus, the switching between different modes of the television device and the automatic playing of the television video on the network can be realized by one button.

The storage module 45 can store the network link. Thus, the network playback module 44 can open the network link after the user presses the button. The playing of the current television program does not have to be interrupted. Accordingly, the user may open the corresponding network link when desired, which will not affect the current TV images, and is very of humanization.

When the network playback module 44 is to display the corresponding content of the network link on the television device, the television device is switched to the network mode and then the network link is opened in the network mode to display the video content corresponding to the network link on the television device.

The network link may be directed to an online video itself, or a list of online videos. As a preferred embodiment, a playing progress information is recorded beforehand in the network link tag. Then, a playing progress of video content on the network link is set according to the playing progress information when the video content on the network link is acquired by the network playback module 44 and displayed on the television device.

That is, the network link tag pre-inserted in each frame of television video not only records the corresponding network link of the television video, but also records the playing progress information of the television video currently playing with respect to the entire television program. The corresponding network link and the playing progress information of the television video can be obtained after the link acquisition module analyzes the network link tag. The corresponding online video may be opened by the network playback module 44 according to the network link, and the playing progress may be set according to the playing progress information.

For example, the television program currently playing on the television device is an image at four minutes and thirty seconds from the beginning of the entire program. At this moment, if the user presses the specific button to trigger the network access instruction for acquiring the television video, then according to the method for controlling network access of the television device, the network link tag such as a two-dimensional code at the current television video is captured and then decoded to obtain the network link corresponding to the television video and the playing progress information of television video, four minutes and thirty seconds. Then, open the network link and display the online video which the network link is directing to, and the playing progress is set to four minutes and thirty seconds. Thus, it allows the user to experience watching television without interrupting.

Furthermore, it may include a mode switching module. If an instruction for returning to the television mode is received after the television device is switched to the network mode, then the television device is switched back to the television mode to display the television video currently playing. Therefore, the television device may be easily switched between the television mode and the network mode.

It should be emphasized that the above-described embodiments of the present invention, are merely possible examples of implementations. Many variations and modifications may be made to the above-described embodiments of the invention without substantially departing from the spirit and principles of the invention. All such modifications and variations are intended to be included herein within the scope of this disclosure and the present invention and protected by the following claims.

1. A method for controlling network access of a television device, comprising:
causing display of a television video on the television device;
causing display of a network link tag preset on the television video being displayed on the television device, the network link tag including an embedded network link that links to a network video having substantially identical content as the television video;
receiving a user selection of the network link tag preset on the television video, the network link tag including television progress information corresponding to an amount of time measured from a start of the television video;
analyzing the network link tag to obtain the network link;
opening the network link; and
causing display of the network video starting at a point in the network video corresponding to the television progress information of the television video.

2. The method of claim 1, wherein the network link tag is a two-dimensional code set at an edge of an image of the television video.

3. The method of claim 1, further comprising storing the network link in response to receiving the user selection, then opening the network link and causing the display of the network video on the television device.

4. The method of claim 3, wherein the step of opening the network link and causing display of the network video on the television device includes:
causing the television device to switch to a network mode, and opening the network link in the network mode and displaying the network video on the television device.

5. (canceled)

6. A module device for controlling network access of a television device, comprising:
a television display module adapted to cause display of a television video on the television device;
a tag display module adapted to cause display of a network link tag preset on the television video being displayed on the television device, the network link tag including an embedded network link that links to a network video having substantially identical content as the television video;
a tag identification module adapted to receive a user selection of the network link tag preset on the television video, the network link tag including playing progress information corresponding to an amount of time measured from a start of the television video;
a link acquisition module adapted to analyze the network link tag to obtain the network link and open the network link; and
a network playback module adapted to cause display of the network video starting at a point in the network video corresponding to the television progress information of the television video.

7. The module device of claim 6, wherein the network link tag is a two-dimensional code set at an edge of an image of the television video.

8. The module device of claim 6, wherein the module device module adapted to store the network link after the link acquisition module obtains the network link; and the network playback module is adapted to open the network link and display the content corresponding to the network link on the television device when the network playback module receives an instruction to access the network link.

9. The module device of claim 8, wherein the network playback module is adapted to switch the television device to a network mode, and open the network link in the network mode to obtain the network video.

10. (canceled)

11. A method for controlling network access of a television device, comprising:
causing the display of a television video on the television device;
inserting a network link tag in a television video, the network link tag having embedded therein a network link corresponding to a network video having substantially identical content to the television video, and further including playing progress information corresponding to an amount of time measured from a start of the television video until the network link is selected;
obtaining the network link tag in response to receiving a user selection to open the network link;
analyzing the network link tag to obtain the network link;
opening the network link; and
causing display of the network video starting at a point in the network video corresponding to the television progress information of the television video.

12. The method of claim 11, wherein the network link tag is a two-dimensional code set at an edge of an image of the television video.

13. The method of claim 11, further comprising storing the network link, in response to receiving the user selection.
